(19) United States
(12) Patent Application Publication
(10) Pub. No.: US 2006/0238551 A1
(43) Pub. Date: Oct. 26, 2006

(54) Liquid crystal display gamma correction

(76) Inventor: Sandeep M Dalal, Cortland Manor, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/552,832

(22) PCT Filed: Apr. 8, 2004
(86) PCT No.: PCT/IB04/01207

§ 371 Date: Oct. 13, 2005

Related U.S. Application Data
(60) Provisional application No. 60/463,748, filed on Apr. 18, 2003.

(51) Int. Cl. G09G 5/10

(52) U.S. Cl. 345/690

(57) ABSTRACT

Gamma correcting procedures suitable for single-panel LCD/LCoS projectors are provided. Initially, linearly derived gamma values are used to produce gray scale color images (such as RED, GREEN, and BLUE). The brightness-voltage characteristics of the projector are determined by measurement and calculation. New gamma correction values are calculated and used to produce new gray scale color images, which are measured to determine their brightness-data responses. Errors with respect to a desired (power-law) response are used to calculate improved gamma correction values. The process of using newly calculated gamma correction values to produce gray scale color images, measuring the gray scale color images to find their brightness-data response, and using errors to obtain new gamma correction values repeats until the brightness-data characteristics of the display matches the desired response and until the display's grayscale tracking meets the desired performance levels. LCD projectors that incorporate the gamma correction values are also taught.

This invention relates to projection displays, and more particularly to LCD panel projectors and gamma correcting for liquid crystal projectors, displays, and the like.

Color imaging systems such as computers and televisions have used cathode ray tubes (CRTs) for many years to produce “moving” color images. However, the desire for low power consuming imaging systems, both for lightweight applications such as portable computers and for large-screen televisions, has spurred the development of numerous alternatives, specifically including Liquid Crystal Display (LCD) projectors. Recent LCD projectors operate by separating white light into primary components (usually red, blue and green), individually modulating the primary components in accord with color information derived from incoming data signals, and then projecting the modulated color information onto a viewing screen to produce a desired full color image. It should be noted that LCD projectors typically use one or more LCD panels to modulate the primary components. Advanced LCD projectors use only one LCD panel modulator and are referred to as single-panel LCD projectors.

An LCD panel is comprised of a liquid crystal material that is sandwiched between two plates. The two plates include various structures, such as conductors, electrodes, and switching elements, that interact with the liquid crystal material to form a plurality of picture elements (pixels) that are arranged in a matrix of m horizontal rows and n vertical columns. In the case of Liquid Crystal on Silicon (LCoS) panels, one of the plates is a silicon chip with an active matrix in which each pixel is individually addressable. A voltage applied across a pixel induces the liquid crystal material at that pixel to undergo a phase change that changes the light polarization vector through the pixel. By varying the voltage, the light polarization at the pixel can be controlled. By incorporating a polarization filter the light from a pixel can be controlled between light and dark limits. Light intensities between the light and dark limits are referred to as gray scales.

Imaging systems that accurately produce a desired color image are highly desirable. Unfortunately, accurately producing a color image is difficult to do. This is because of various factors such as the non-linear visual perception of observers, white light sources that do not produce the optimum color spectrum, light distortion produced by optical elements such as prisms, polarizers, filters, and lenses, inherent limitations of LCD panel modulators, and electronic subsystems that have a limited ability to process the infinite range of possible colors.

Limitations of LCD panel modulators and electronic subsystems overlap in the area of gamma correction. Incoming data signals are normally formatted on the assumption that the color image will be displayed on a CRT, a device that has a pronounced non-linear luminance-voltage transfer response. On a CRT display, the incoming data signals would produce red, green, and blue light outputs or luminance values that each vary in accord with a power law function such as L=kV^{2.2}, where k is a constant, L is luminance, and V is voltage. The exponent, 2.2, is typically referred to as the gamma of the display. This brightness-to-voltage power law function is a desired characteristic for a display. However, LCD panel modulators do not follow that power law function. Thus, to produce the desired luminance LCD projectors typically include gamma correction, usually in the form of gamma look-up tables, one table for each of the primary (RGB) colors. The combination of the gamma look-up tables and the LCD display's non-linear luminance-voltage transfer response (referred to as the B-V response of the LCD panel) together should produce the desired power law function.

Unfortunately, in single panel LCD/LCoS projectors, where multiple colors are sequentially scanned at a high frame rate, the analog voltage imposed upon a liquid crystal pixel depends not only upon the voltage determined by the gamma table, but also to a smaller extent on the voltage that was imposed upon the pixel for the previously driven color. This residual color dependency, also referred to as color crosstalk, produces a B-V response that causes color inaccuracies in the displayed image. Specifically, we could expect that if all three color data channels in a single-panel projector would meet the power-law curve requirement in the display, then for all gray drive levels (i.e. the R, G, and B data values provided to the projector are equal to each other with the intention to produce a neutral gray image), ideally the ratios of the three color light outputs would be the same at all gray drive levels, and that this would enable a desirable characteristic of grayscale tracking to be achieved on the display. But due to the interdependencies of the color drive voltages in the single-panel LCD/LCoS display we do not get perfect power-law tracking, and thus do not achieve good grayscale tracking.

Thus, while gamma tables are beneficial, they have not been able to produce the color characteristics and grayscale tracking that are desired in high-quality single panel LCD/LCoS projectors. One reason for this is that the gamma tables have not contained table values that accurately compensate for color crosstalk. A reason that the gamma table values have not produced the desired results is that a procedure for determining gamma table values that accurately compensate for color crosstalk has not been available.

Therefore, a new procedure for producing gamma corrected values would be beneficial. Also beneficial would be gamma tables that convert applied (RGB) digital pixel data to gamma corrected (RGB) values that compensate for the previously displayed color. Even more beneficial would be a single-panel LCD projector that is gamma compensated in accord with the B-V characteristics of the LCD panel and with previously displayed colors.

To address one or more of these issues, a method of producing gamma corrected values, described herein, uses initial, linearly derived tristimulus gamma values to produce tristimulus images, measures the tristimulus images, and obtains the brightness-voltage (B-V) characteristics of the images. Then a calculation process is performed in which new tristimulus gamma corrected values are calculated that produce a predetermined power-law response from the obtained characteristics of the images, these newly calculated gamma corrected values are used to produce new tristimulus images, and these tristimulus images produced are measured and the brightness-data characteristics of the images are obtained. This calculation process is repeated until the gamma corrected values produce brightness-data characteristics that meet predetermined power-law characteristics.

In another aspect of the invention, a method of gamma correcting an LCD display as disclosed herein includes storing initial, linearly derived, RED, GREEN, and BLUE gamma values in RED, GREEN, and BLUE gamma tables. The linearly derived gamma values are used to produce RED, GREEN, and BLUE images using an LCD panel. The image characteristics are measured and the brightness-voltage (B-V) characteristics of the LCD panel are obtained. Those characteristics are used to determine RED, GREEN, and BLUE gamma correction values that produce a predetermined power-law response. The gamma correction values are stored and used to produce new images using the LCD panel. The image characteristics are measured, and the brightness-data characteristics of the LCD panel are determined using the new measurements. New gamma correction values are determined, stored, and used to produce images whose characteristics are measured. The process repeats until final gamma correction values, which produce LCD panel brightness-data characteristics that meet the predetermined power-law characteristics are obtained. The final gamma correction values are then stored for future use.

In yet another aspect of the invention, a projector disclosed herein comprises a set of three primary color gamma tables that convert pixel data into gamma corrected data for an associated primary color, an LCD panel modulator for selectively modulating input light beams in response to gamma correction data from the three primary color gamma tables; a light source that selectively applies three primary color light beams to the LCD panel modulator; an input system for producing primary color digital pixel data for each of the primary color gamma tables; and an imaging system for producing an image on a viewing screen from the modulating input light beams from the LCD panel modulator. The gamma correction data in each of the three primary color gamma tables is determined by one of the methods described above.

In the drawings:

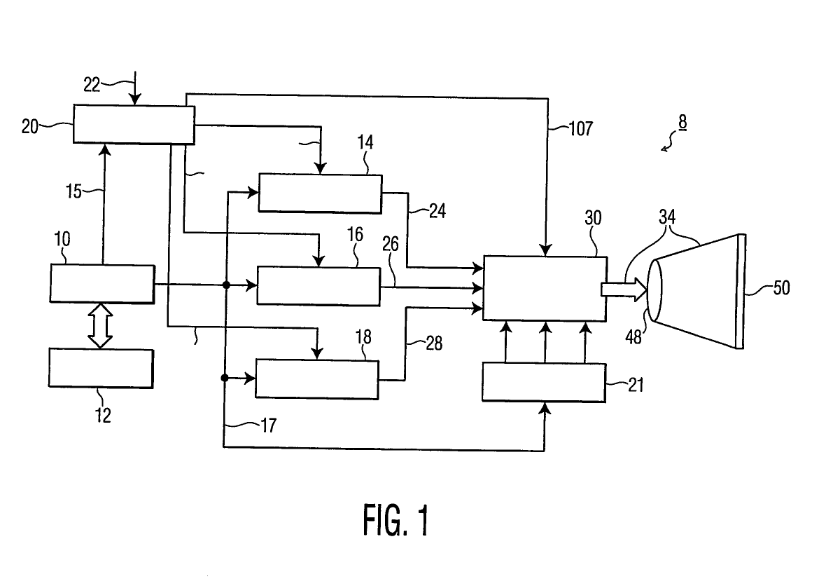

FIG. 1 represents a single-panel LCD projector that is usable with an embodiment of the invention;

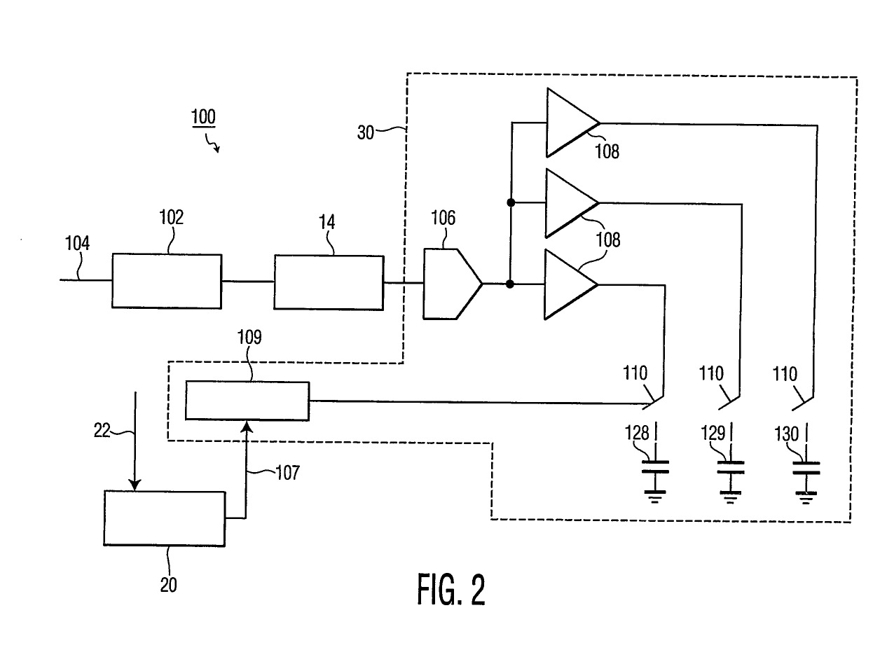

FIG. 2 illustrates signal flow in a single-panel LCD projector such as the projector of FIG. 1;

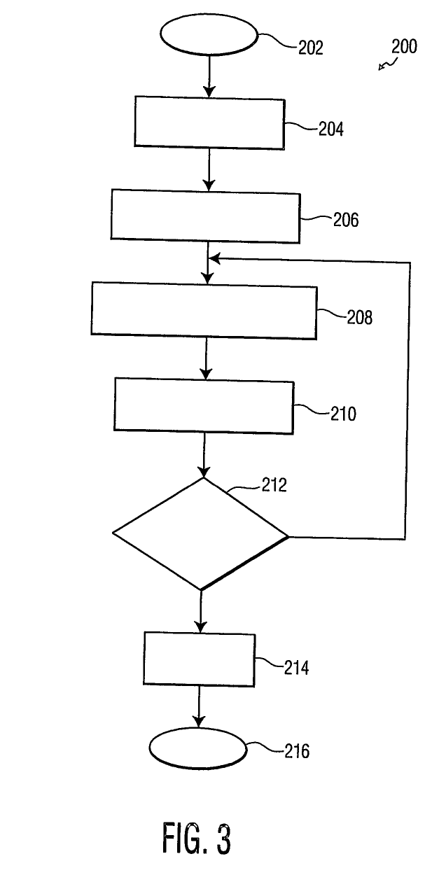

FIG. 3 is illustrative of a procedure used to determine gamma corrected values for a single-panel LCD projector in accordance with the invention; and

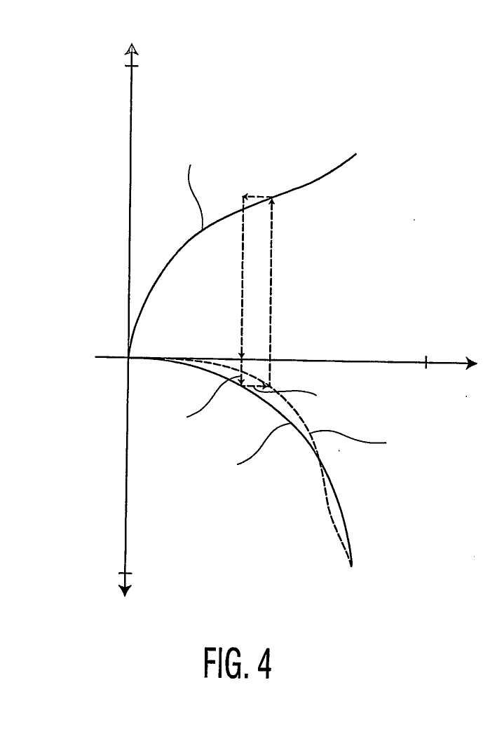

FIG. 4 illustrates how a particular algorithm determines gamma corrected values.

FIG. 1 represents a single-panel LCD projector 8 that has a gamma table for each primary color. The single-panel LCD projector 8 includes a controller 10 that controls the overall operation of the projector. During initialization, the controller 10 retrieves gamma correction data from a memory 12. The controller 10 sends RED gamma correction data to a RED gamma table 14, GREEN gamma correction data to a GREEN gamma table 16, and BLUE gamma correction data to a BLUE gamma table 18, all via a data bus 17. The determination of the gamma correction data is explained in more detail subsequently.

The controller 10 also controls the operations of a data input system 20, via a bus 15, and of a light source 21, via the data bus 17. The data input system 20 converts incoming data signals (such as television signals or signals from a computer) on a line 22 to 8-bit (or more, if needed by the application and provided for in the display) color image signals R_{IN}, G_{IN}, and B_{IN} that represent the color image that is to be produced. R_{IN} is applied to the RED gamma table 14, G_{IN} is applied to the GREEN gamma table 16, and B_{IN} is applied to the BLUE gamma table 18.

Based on the gamma correction data from the memory 12, the RED gamma table 14 converts R_{IN} to gamma corrected RED data on a bus 24, the GREEN gamma table 16 converts G_{IN} to gamma corrected GREEN data on a bus 26, and the BLUE gamma table 18 converts B_{IN} to gamma corrected BLUE data on a bus 28. Under the overall control of the controller 10, the gamma corrected RED, GREEN, and BLUE data selectively control the operation of an LCD panel modulator 30 by way of a bus 107 from the input system 20.

The controller 10 controls the light source 21 such that RED light R, GREEN light G, and BLUE light B are sequentially applied to the LCD panel modulator 30. In a first color sub-frame the RED light R is applied to the LCD panel modulator 30, which then modulates the RED light R in accord with the gamma corrected RED data to produce a modulated light beam 34. The modulated light beam 34 passes through an optical system 48 that sweeps the modulated light beam 34 across a viewing screen 50. In the next color sub-frame the GREEN light G is applied to the LCD panel modulator 30, which modulates the GREEN light G in accord with the gamma corrected GREEN data to produce the modulated light beam 34. In the next color sub-frame the BLUE light B is applied to the LCD panel modulator 30, which then modulates the BLUE light B in accord with the gamma corrected BLUE data to produce the modulated light beam 34. By rapidly switching between RED, GREEN, and BLUE an observer sees a full color image on the viewing screen 50. In some single panel projection architectures the three-color sub-frames are simultaneously applied in a spatially offset format to the LCD panel modulator. Then, stripes or bands of light scroll across that panel in some given orientation. In any case, an observer perceives a full color image when the sub-frames are scanned at a high frame rate on the panel

FIG. 2 illustrates the applications of gamma corrected color data to the LCD panel modulator 30 in more detail. For convenience, FIG. 2 specifically illustrates the application of gamma corrected RED data, but the other colors are processed similarly. First, a counter 102 receives timing signals from a precision clock (which is not shown for clarity) on a line 104. In response, the counter 102 produces a sequence of 256 digital values that are applied to the RED gamma table 14. These 256 clock periods together correspond to the drive time for one row of the display panel. In the case of a single-panel display, each row of the panel is driven by voltages for a single color at any instant in time, and during the display frame period all the rows are driven in a sequential manner with the drive voltages for each of the three colors at appropriate times. As mentioned, the RED gamma table 14 stores gamma correction table values for the RED data.

Still referring to FIG. 2, the RED gamma table 14 maps the digital values from the counter 102 into a sequence of gamma corrected RED data values that have a fixed resolution, of 13 bits (one of 8192 possible values) for example. The gamma corrected RED data values are input to a digital-to-analog converter (DAC) 106, which is part of the LCD modulator 30. The DAC 106 converts the sequence of gamma corrected RED data values into discrete analog voltages that are applied to column drivers 108 (only three are shown for clarity, in practice there will be say 1280 column drivers 108, one for each column in the display). The column drivers 108 apply the analog voltages from the DAC 106 to the LCD panel's columns. For a specific column, when the desired red data value for that column is reached by the counter 102, a signal from the input system 20 applied on a bus 107 to a switching matrix 109 causes a switch 110 to disconnect that column (the pixel on the given row for that column is represented by a capacitance 128) from its column driver 108. The applied voltage from the column driver 108 is retained on the capacitance 128 until the given row is driven by the specific color data for the next color sub-frame. Other columns (and pixels for the given row represented by capacitances 129, 130, and so on) will continue to charge until their predetermined values are reached, at which time they are disconnected from their associated line drivers 108.

The analog voltage retained by the capacitance 128 is selected to produce a particular grayscale. As previously indicated, the input signals on the line 22 (see FIGS. 1 and 2) can be based on (i.e. precompensated to account for) a luminance-voltage transformation for a CRT. The input system 20 converts those input signals to digital pixel RGB data. However, the response of an LCD modulator 30 is very different than that of a CRT. Without gamma correction, the digital pixel RGB data is not suitable for driving the LCD modulator 30. Correcting the digital pixel RGB data to the analog voltage values for generating correct luminance outputs for all gray levels is the task of the RED, GREEN, and BLUE gamma tables 14, 16, and 18, which transform the digital pixel RGB data values from the input system 20 to digital values that produce analog voltages from the DAC 106 that produce the prescribed color and luminance on the viewing screen 50. Thus, the gamma tables compensate for the non-linear optoelectronic response of the LCD modulator 30 to produce well-defined RGB luminance and color profiles.

Gamma tables can be generated using a single step procedure. First, a particular gamma table is loaded with digital values derived from a linear transfer function under the assumption that the LCD's analog voltages will then be linearly proportional to pixel data. Then, the LCD's non-linear optoelectronic response, often called the brightness-voltage curve (B-V curve), is determined by measuring the LCD's B-V response for each of the red, green, and blue colors using the linear red, green, and blue digital data values. It is desired that the overall response should follow a power-law function, i.e. the display should output defined red, green, and blue brightness levels based on a power-law curve (something like L=V^{2.2}), with the actual function being dependent on the LCD modulator panel 30. Then, the measured B-V curve is inverted, i.e. for the 256 known or desired brightness levels based on the power-law curve, each corresponding to a specific 8-bit data value, gamma correction look-up table values that produce the required analog voltages are determined (generally by interpolation) and then stored for future use (such as in the memory 12).

However, with single-panel LCD projectors it has become apparent that the single-step procedure is insufficient for state-of-the-art, high quality imaging. In fact, underlying non-idealities in LCD panel displays produce a deviation between the ideally calculated or desired brightness-data power-law curve and the measured brightness-data curve produced by the gamma correction tables generated by the single-step procedure. Such deviations are caused by the temporal dynamics of LCD panels in which the time required for the liquid crystal to change its orientation/twist depends upon the applied analog voltage. The analog voltage imposed upon a liquid crystal pixel depends not only upon the voltage determined by the gamma table, but also to a smaller extent on the voltage that was imposed upon the pixel for the previously driven color. Since single panel LCD projectors are scanned at a much faster rate than multiple panel LCD projectors, the drive time for each color is quite small and the rise/fall time of the brightness response is a significant portion of the total drive time. Therefore, these issues are more pronounced in single panel LCD projectors and lead to color inaccuracies in the displayed image.

In accordance with the invention, more accurate gamma tables can be obtained in an iterative fashion. The initial, linearly derived RED, GREEN, and BLUE gamma table values are used to produce gray images (i.e. equal R, G, and B data values), and then the RED, GREEN, and BLUE luminance images output by the display are measured to obtain the brightness-data characteristics of the display. Then, new sets of RED, GREEN, and BLUE gamma correction look-up table values are calculated so as to produce a suitable brightness-data power-law response. Then, the newly calculated gamma correction values are used to produce new gray images, which are again measured to determine the RED, GREEN, and BLUE brightness-data characteristics. Errors in the brightness-data responses are then determined and used to calculate new RED, GREEN, and BLUE gamma correction values that provide a closer match to the desired power-law response. The process of using the newly calculated gamma correction values to produce images, measuring the images to find the brightness-data response, and using the errors to obtain new gamma correction values, continues iteratively until the brightness-data characteristics of the display matches the desired power-law characteristics and until the display's grayscale tracking meets the desired performance levels.

The principles of the invention further allow for single-panel LCD projectors, such as depicted in FIG. 1, that have improved gamma correction. Improved gamma correction is beneficially achieved by using RED, GREEN, and BLUE gamma tables that store gamma correction values produced by an iterative procedure. The iterative procedure includes using initial, linearly derived RED, GREEN, and BLUE gamma data to produce an image using an LCD panel modulator. Then, measuring the RED, GREEN, and BLUE images to obtain the brightness-data characteristics of the LCD panel modulator. Then, calculating RED, GREEN, and BLUE gamma correction values that produce a suitable power-law response. Then, using the newly calculated gamma correction values to produce new images using an LCD panel modulator, which are again measured to determine the RED, GREEN, and BLUE brightness-data characteristics. Errors in the brightness-data responses are then determined and used to calculate new RED, GREEN, and BLUE gamma correction values that provide a closer match to the desired power-law response. The process of using the newly calculated gamma correction values to produce images using the LCD panel modulator, measuring the image to find the brightness-data response, and using the errors to obtain new gamma corrected values repeats until the brightness-data response characteristics of the display matches the desired power-law characteristics and until the display's grayscale tracking meets the desired performance levels. Beneficially, the gamma correction values that produce an acceptable brightness-data response characteristic are stored for future use, such as in the memory 12.

Reference will now be made in detail FIG. 3, which illustrates a procedure 200, which is in accord with the present invention, to determine gamma correction values for gamma tables (such as the gamma tables 14, 16, and 18 in FIG. 1). As shown, the procedure starts, step 202, and continues by loading RED, GREEN, and BLUE gamma tables with linearly derived gamma values, step 204. Then, the luminance (brightness) and color properties of the LCD panel modulator 30 (see FIG. 1) are measured using the linear gray image values, step 206.

The measurements of the luminance (brightness) and color properties (effectively measuring the brightness-data response of the panel to each of the color channels), together with the properties of the DAC 106 (see FIG. 2), are used to obtain the B-V response of the LCD panel modulator. Based on the obtained B-V response, new sets of gamma correction values are calculated and loaded into the RED, GREEN, and BLUE gamma tables, step 208. Thus, initially the procedure 200 is similar to the single-step procedure. However, unlike the single-step procedure, the gamma correction values calculated in step 208 are used to produce new gray images on the LCD panel. The resulting luminance and color characteristics of the new images are measured, step 210 in a similar manner as the measurements of step 206. A determination is then made as to whether the LCD panel is gamma corrected within acceptable limits, step 212. In a subjective sense, acceptable limits are beneficially set such that the LCD panel's gamma corrections are sufficiently accurate that a trained observer would find images produced by the LCD panel of high quality. In objective terms, acceptable limits are set by determining an error criterion comparing the measured brightness-data response of the display for all three colors with respect to the ideal or desired power-law brightness-data response.

If the determination is that gamma correction is not within acceptable limits, then the procedure 200 iteratively loops back to step 208 to calculate and load new RED, GREEN, and BLUE gamma correction values into the tables. Preferably, the new RED, GREEN, and BLUE gamma correction values are calculated based on errors found in step 212. That is, the algorithm used to obtain the new gamma table values uses errors between the measurements taken in step 210 and the desired power-law response. Then, the newly calculated gamma correction values are used to drive the LCD panel (step 208), and new luminance and color measurements are made (step 210). A new determination is made as to whether the LCD panel is gamma corrected within acceptable limits, set 212. If not, the procedure repeats. However, if the determination is made in step 212 that the LCD panel 30 is gamma corrected within acceptable limits, the procedure 200 stops, step 214.

It should be noted that the procedure 200 does not require additional or new equipment as compared to the single-step procedure. However, a new algorithm that calculates gamma correction values based on the errors determined in step 212 is beneficial. That algorithm, which will depend on the particular system being gamma corrected, will be easily arrived at by those skilled in the applicable arts after taking into consideration the desired result, the available measurement equipment, the selected acceptance criteria, and the particular system being gamma corrected. However, to assist others, a procedure that is beneficial to the assignee of the present now will be described.

It should be noted that the final gamma tables provide a desired transfer function from gray level (G) to normalized luminance (Ld) using an idealized power-law response:
L_{d}(G)=(G/255)^{γ} (1)

Although equation 1 is conceptually correct, in practice the luminance never goes to 0 for gray level 0 (the black state). This is because of a finite contrast value for each R, G, or B channel. Therefore, in practice, Equation 2 is used:
L_{d}(G)=L₀+L₁(G/255)^{γ} (2)
where L₀ and L₁ are respectively offset and gain factors used to model the minimum luminance and the luminance dynamic range for any color.

In reality the measured luminance response deviates from the desired power-law response. However, the iterative gamma table update procedure described above compensates for that deviation. First, initial gamma table values, designated g₀(x), are loaded into the gamma tables, where the subscript 0 refers to the iteration number. The next set of gamma table values is g₁(x), and so on. The initial gamma table values are linear and monotonic. The measured luminance output of the display as a function of a gray level G(x) is written as Lₘ(x), while the desired luminance function is written as L_{d}(x).

With g₀(x) loaded into the tables the luminance responses Lₘ(x) for a set of at least 25 gray levels G(x) (possibly equally spaced) that range from 0 to 255 are measured. For example, the gray levels could 0, 10, 20, 30, . . . 240, 250, and 255. The luminance responses are either for a single color (red, green or blue), or a measurement device that determines the red, green and blue luminance components from a single color measurement can be used. Each color's maximum luminance is normalized such that the function Lₘ(x) reaches a maximum of 1.0 at gray level G(255).

FIG. 4 illustrates a gamma table curve, gₙ(x) as well as normalized Lₘ(x) and normalized L_{d}(x) curves for a single color as functions of gray levels that range from 0 to 255. The four steps shown (Step 1 to Step 4) outline an algorithmic procedure to update a gamma curve from a current iteration so that the next iteration in the measurement of the brightness-data curve will more accurately match the desired brightness-data curve. An estimate of the “fit” of the results of the gamma table values to the desired power law could be found by comparing Lₘ(x) with L_{d}(x). Ideally the two curves should overlap, but as previously suggested, some errors can be expected at some or all gray levels.

To update the gamma table and therefore improve the fit, we describe the four steps shown in FIG. 4. We first select a single gray level (G=128, for example) from 0 to 255. The desired normalized light output for this gray level, labeled L_{d} (shown as the result of Step 1 in FIG. 4), is calculated using the desired power-law function of equation 2.

Next, the gray level G_{d} that produces the desired light output L_{d} from the current gamma table for the selected gray level G, is calculated by means of a reverse interpolation procedure using the measured brightness-data curve Lₘ(x). Reverse interpolation implies that the measured luminance is the independent variable and the calculated gray level G_{d} is the dependent variable. The interpolation procedure interpolates the value L_{d} from the Lₘ(x) curve to calculate G_{d}. This is shown as Step 2 in FIG. 4. It should be noted that, due to interpolation, the calculated gray level G_{d} will not necessarily be an integer value; thus it preferably has a floating-point representation between 0 and 255. Note that the function Lₘ(x) must be monotonic for the reverse interpolation to work properly. However, if the original table values g₀(x) are selected properly, the luminance function Lₘ(x) will be monotonic. This implies that the light output desired for gray level G is equal to the light produced by gray level G_{d} when using the current gamma table, mathematically L_{d}(G)=Lₘ(G_{d}). For our example, if G=128 was selected in Step 1, then the desired light output for gray level G=128 was actually produced by the gamma table entry for gray level G_{d}; this value may be slightly different from the gray level value of 128, but could be greater or smaller depending upon the error in the fit of the measurements to the desired power law.

Next, for the calculated gray level G_{d}, the gamma table value for the next iteration is found using the currently loaded gamma table—the curve gₙ(x) in the upper quadrant of FIG. 4 represents the currently loaded gamma table. This is performed by interpolating the current gamma table voltage values gₙ(x), to find an updated gamma table entry, shown as V_{d}, for the gray level G_{d}. This is shown as Step 3 in FIG. 4. This interpolation is quite simple because the current gamma table entries are monotonic, so all that is required is to interpolate a new entry using entries in the gamma table nearest the calculated gray level G_{d}. One could use linear interpolation or low-order polynomial/spline interpolation for this calculation.

Next, Step 4 in FIG. 4 assigns this gamma table entry, V_{d}, to form the next iteration's gamma table gₙ₊₁(x) entry for gray level G.

In summary, Steps 1 to 4 demonstrate how we can calculate an updated gamma table entry, V_{d}, for a selected gray level G given an existing gamma table gₙ(x), a desired brightness-data curve, L_{d}(x), and a curve representing measurements, Lₘ(x), of the brightness-data for the existing gamma table. If we repeat Steps 1 to 4 for all gray levels from 0 to 255, we can calculate new gamma table entries for each of the gray levels and therefore generate a new gamma table curve gₙ₊₁(x). The new gamma table curve, when loaded into the projector's electronics, will provide a more accurate match to the desired brightness-data curves than the previous gamma table. The process then iterates to create a gamma table that meets the error criteria.

The embodiments and examples set forth herein are presented to explain the present invention and its practical application and to thereby enable those skilled in the art to make and utilize the invention. Those skilled in the art, however, will recognize that the foregoing description and examples have been presented for the purpose of illustration and example only. Other embodiments, variations of embodiments, and equivalents, as well as other aspect, objects, and advantages of the invention, will be apparent to those skilled in the art. For example, while the foregoing has described using three primary light colors, the general scheme is also applicable to systems that use more light colors. Thus, the principles of the present invention can be obtained from a study of the drawings, the disclosure, and the appended claims.

1. A method of producing gamma corrected values, comprising:
(a) using initial, linearly derived gamma values to produce gray level images for a color;
(b) measuring the gray level images;
(c) obtaining the brightness-voltage (B-V) characteristics of the gray level images;
(d) calculating new gamma corrected values that produce a predetermined response from the obtained characteristics of the gray level images;
(e) using the newly calculated gamma corrected values in step (d) to produce new gray level images;
(f) measuring the gray level images produced in step (e);
(h) obtaining the brightness-data characteristics of the gray level images from the measurements of step (f); and
(i) repeating steps (d) through (h) until the gamma corrected values produce brightness-data characteristics that meet predetermined characteristics.

2. The method of claim 1, wherein step (i) further includes repeating steps (d) through (h) until the image's gray scale tracking meets predetermined performance levels.

3. The method of claim 1, wherein step (d) includes using errors in the brightness-data characteristics to calculate new gamma corrected values.

4. The method of claim 1, wherein the color is a primary color.

5. A method of gamma correcting an LCD display, comprising:
(a) storing initial, linearly derived, RED, GREEN, and BLUE gamma values in RED, GREEN, and BLUE gamma tables;
(b) using the initial linearly derived, RED, GREEN, and BLUE gamma values to produce RED, GREEN, and BLUE gray scale images using an LCD panel;
(c) measuring the RED, GREEN, and BLUE gray scale images produced in step (b);
(d) obtaining the brightness-voltage (B-V) characteristics of the LCD panel;
(e) using the obtained characteristics of the LCD panel to calculate RED, GREEN, and BLUE gamma correction values that produce a predetermined power-law response;
(f) storing the RED, GREEN, and BLUE gamma correction values calculated in step (e) in the RED, GREEN, and BLUE gamma tables;
(g) using the RED, GREEN, and BLUE gamma tables with the RED, GREEN, and BLUE gamma correction values stored in step (f) to produce new RED, GREEN, and BLUE gray scale images on the LCD panel;
(h) measuring the RED, GREEN, and BLUE gray scale images produced in step (g);
(i) obtaining the brightness-data characteristics of the LCD panel from the measurements taken in step (h); and
(j) repeating steps (e) through (i) until final gamma correction values that produce LCD panel brightness-data characteristics that meet predetermined power-law characteristics are obtained; and
(k) storing the final gamma correction values for future use.

6. The method of claim 5, wherein step (j) further includes repeating steps (e) through (i) until the LCD panel's grayscale tracking meets predetermined performance levels

7. The method of claim 5, wherein step (e) includes using errors in the brightness-data characteristics of the LCD panel to calculate new RED, GREEN, and BLUE gamma correction values.

8. A projector, comprising:
a set of at least three color gamma tables, each of which converts pixel data into gamma correction data for an associated color;
an LCD panel modulator for selectively modulating input light beams in response to gamma correction data from the at least three color gamma tables;
a light source that selectively applies at least three color light beams to the LCD panel modulator;
an input system for producing color digital pixel data for each of the at least three color gamma tables; and
an imaging system for producing an image on a viewing screen from the modulating input light beams from the LCD panel modulator;
wherein the gamma correction data in each of the at least three color gamma tables is determined by:
(a) using initial, linearly derived color gamma values to produce gray scale images;
(b) measuring the produced gray scale images;
(c) obtaining the brightness-voltage (B-V) characteristics of the produced gray scale images;
(d) calculating new gamma correction values that produce a predetermined response from the obtained characteristics of the produced gray scale images;
(e) using the newly calculated gamma correction values in step (d) to produce new gray scale images;
(f) measuring the gray scale images produced in step (e);
(h) obtaining the brightness characteristics from the measurements of step (f);
(i) repeating steps (d) through (h) until the gamma correction values produce brightness-data characteristics that meet predetermined characteristics; and
(j) storing the gamma correction values for each of the at least three colors in its associated gamma table.

9. The projector of claim 8, wherein step (i) further includes repeating steps (d) through (h) until the gamma correction values produce grayscale tracking that meets predetermined performance levels.

10. The projector of claim 8, wherein step (d) includes using errors in the brightness-data characteristics to calculate new gamma correction values.

11. The projector of claim 8, wherein the at least three gamma tables are RED, GREEN, and BLUE.

12. The projector of claim 8, wherein the predetermined response is a power-law response.

13. The projector of claim 8, wherein a controller controls the light source.

14. The projector of claim 8, further including an input system that produces digital pixel data from incoming data signals.

15. The projector of claim 14, wherein the incoming data signals are television signals.

16. The projector of claim 14, wherein the incoming data signals are from a computer.

17. The projector of claim 8, wherein the LCD panel modulator includes a digital-to-analog converter.

18. The projector of claim 17, wherein the LCD panel modulator further includes a driver for driving a line with analog information.

19. The projector of claim 18, wherein the LCD panel modulator further includes a switch matrix.

20. The projector of claim 17, wherein the imaging system includes an optical system that projects light onto a screen.
